(19) United States
(12) Patent Application Publication
(10) Pub. No.: US 2013/0266279 A1
(43) Pub. Date: Oct. 10, 2013

(54) OPTICAL CONNECTOR

(71) Applicants: Daizo Nishioka, Yokohama-shi (JP); Shinji Ogawa, Yokohama-shi (JP); Yukihiro Yokomachi, Yokohama-shi (JP)

(72) Inventors: Daizo Nishioka, Yokohama-shi (JP); Shinji Ogawa, Yokohama-shi (JP); Yukihiro Yokomachi, Yokohama-shi (JP)

(73) Assignee: SUMITOMO ELECTRIC INDUSTRIES, LTD., Osaka-shi, Osaka (JP)

(21) Appl. No.: 13/805,208

(22) PCT Filed: Jun. 17, 2011
(86) PCT No.: PCT/JP11/63883

§ 371 Date: Dec. 18, 2012

(30) Foreign Application Priority Data
Jun. 22, 2010 (JP) 2010-142001

(51) Int. Cl. G02B 6/38

(52) U.S. Cl. CPC G02B 6/3801
USPC 385/99

(57) ABSTRACT

In an optical connector of the invention, the rotation in a conventional angle polish connector can be prevented, while external force acting on the connector can be prevented from affecting a ferrule. The optical connector includes a ferrule 15, which has an angle-polished front portion and is accommodated in a housing 19 in a state where pressing force is applied in a coupling-forward direction by an elastic means so as to enable the ferrule 15 to move in the axial direction. A key groove 21 and a key 23 which are provided between the housing 19 and the ferrule 15 are engaged so as to make their relative movement possible in the movement direction. The clearance C between the groove width W of the key groove 21 and the key 23 increases along the direction in which the ferrule 15 retreats.

### TECHNICAL FIELD

The present invention relates to an optical connector having a ferrule whose front portion is angle polished.

### BACKGROUND ART

Japanese Patent Application Publication No. H10-221568 and Japanese Patent Application Publication No. 2002-6174 describe an optical connector containing a ferrule having a key groove for regulating a rotation around the axis. In FIG. 9, area (a) shows a partially cut away side view of a conventional optical connector 500, area (b) shows a perspective view of a ferrule 503 included in the optical connector 500, and area (c) shows a sectional view of a plug frame (housing) 501 contained in the optical connector 500. In the optical connector 500, the ferrule 503 of cylindrical form contained in the plug frame 501 has a flange 505 around an outside circumferential part. The plug frame 501 is capable of sliding in the axial direction, while the rotational movement around the axis is regulated by engaging keys 509, which are formed inside the plug frame 501 (area (c)), and key grooves 507, which are formed in the flange 505 (area (b)).

The ferrule 503 is designed to be pushed toward a coupling end face 503a by a spring 511 provided in the plug frame 501. The ferrule 503 is prevented from moving forward in the coupling direction beyond that when the flange 505 butts against the stopper wall 515 which protrudes in a ferrule storage hole 513 formed inside the plug frame 501.

The ferrule 503 is connected with a ferrule of another optical connector by butting the coupling end face 503a against the counterpart, and consequently an optical fiber 517, which is terminated to be capable of being detachably connector-coupled, is connected with an optical fiber of such optical connector. The ferrule 503 can slightly be pushed backward in the coupling direction within an elastic limit of the spring 511 at the time of butting with the ferrule of a counterpart optical connector. This enables preventing the coupling end face 503a being damaged by excessive stress concentration, and the pushing force of the spring 511 functions as a force for mutual butting of the ferrules, so that a target coupling loss can stably be attained.

A conventional optical connectors in which low reflection is realized adopts a technique for reducing reflection at a physical contact surface by means of angled physical contact (APC) polish. It is known that in order to stably achieve physical contact (PC) of angle polished coupling surfaces, it is important to suppress the rotational angle of a ferrule to 2 degrees or less. It might be conceivable to make such rotational angle to be zero in order to achieve more stable characteristic; however, if the rotation of the ferrule is completely restrained, PC coupling might be decoupled when an external force is applied to the connector main body, and consequently the characteristic might become unstable.

### SUMMARY OF INVENTION

### Technical Problem

The object of the present invention is to provide an optical connector in which the rotation of a ferrule in an angle polish optical connector can be prevented and with which decoupling can be prevented when an external force acts on the connector.

### Solution to Problem

To this end, an optical connector of the invention comprises: a ferrule having an angle-polished end face; a housing for accommodating and holding the ferrule, allowing the ferrule to move in the axial direction; an elastic means for pushing the ferrule forward in the coupling direction; and further comprises a key and a key groove which are provided between the housing and the ferrule and are engaged with each other, allowing their relative movement along the axial direction, wherein the clearance between the key and the key groove increases along the direction of the ferrule's retreat. It is preferable that the maximum allowance for relative rotational movement as defined by the key and the key groove about their axis be equal before and after the retreat of the ferrule.

### Advantageous Effects of Invention

With the optical connector according to the present invention, it is possible to prevent rotation of a ferrule in an angle polish optical connector, as well as decoupling of the optical connector when external force acts on the connector.

### BRIEF DESCRIPTION OF DRAWINGS

FIG. 1 is an outside perspective view of an optical connector according to an embodiment of the present invention.

FIG. 2 is a cross-sectional view of a main part of the optical connector shown in FIG. 1.

FIG. 3 is a perspective view of a mechanical splice contained in the optical connector shown in FIG. 1.

FIG. 4 is a perspective view of a housing contained in the optical connector shown in FIG. 1.

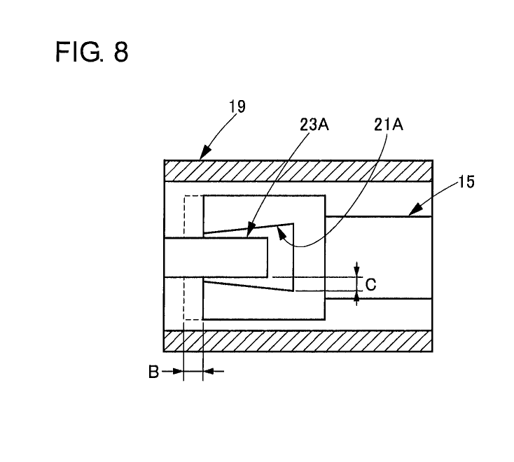

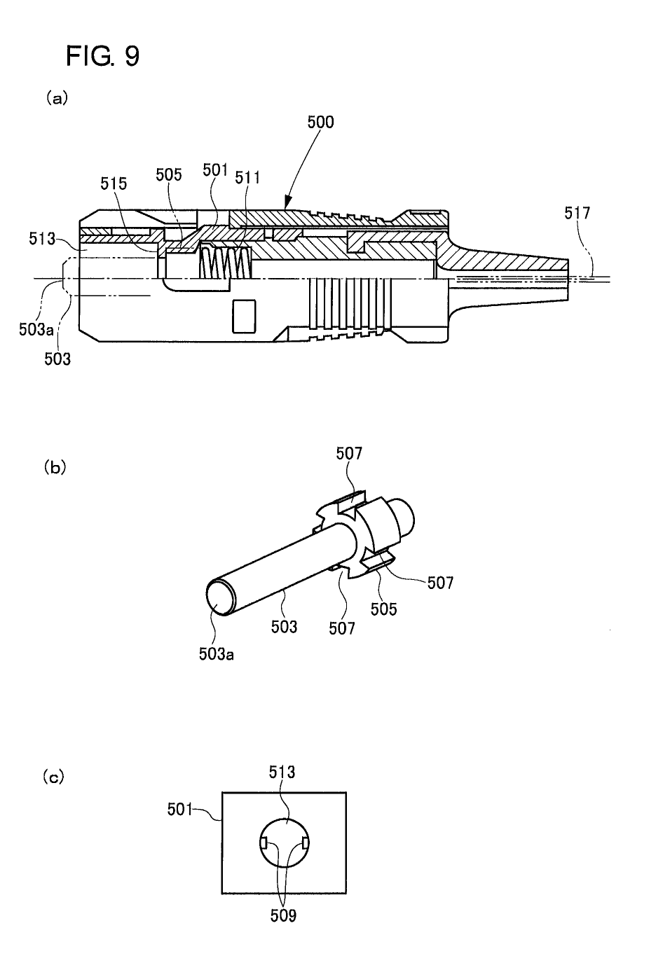

IN FIG. 5, area (a) is a partially cut away perspective view of the housing shown in FIG. 4; area (b) is an enlarged partial view of area (a) of FIG. 5.

In FIG. 6, areas (a) and (b) are schematic diagrams of main part of a conventional optical connector as seen before and after the retreat of a ferrule in the connector.

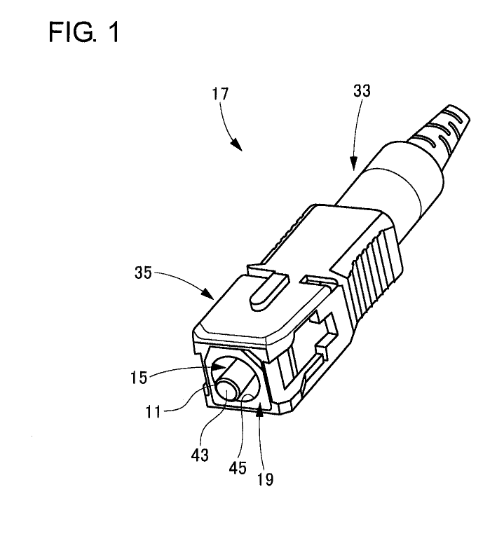

In FIG. 7, areas (a) and (b) show schematic diagrams of main part of the optical connector shown in FIG. 1, as seen before and after the retreat of the ferrule, respectively; area (c) is a schematic diagram of main part of the optical connector of FIG. 1, as seen at a headshake of the ferrule.

FIG. 8 is a schematic diagram of a main part of a modified example of an optical connector according to the present invention.

In FIG. 9, area (a) is a partially cut away side view of a conventional optical connector; area (b) is a perspective view of a ferrule contained in the conventional optical connector; and area (c) is a sectional view of a plug frame contained in the conventional optical connector.

### DESCRIPTION OF EMBODIMENTS

Hereinafter, preferred embodiments of the present invention will be described with reference to the accompanying drawings. The drawings are provided for the purpose of explanation and are not intended to limit the scope of the invention. In the drawings, an identical mark represents the same element and the repetition of explanation is omitted. The ratio of dimensions in the drawings is not necessarily exact.

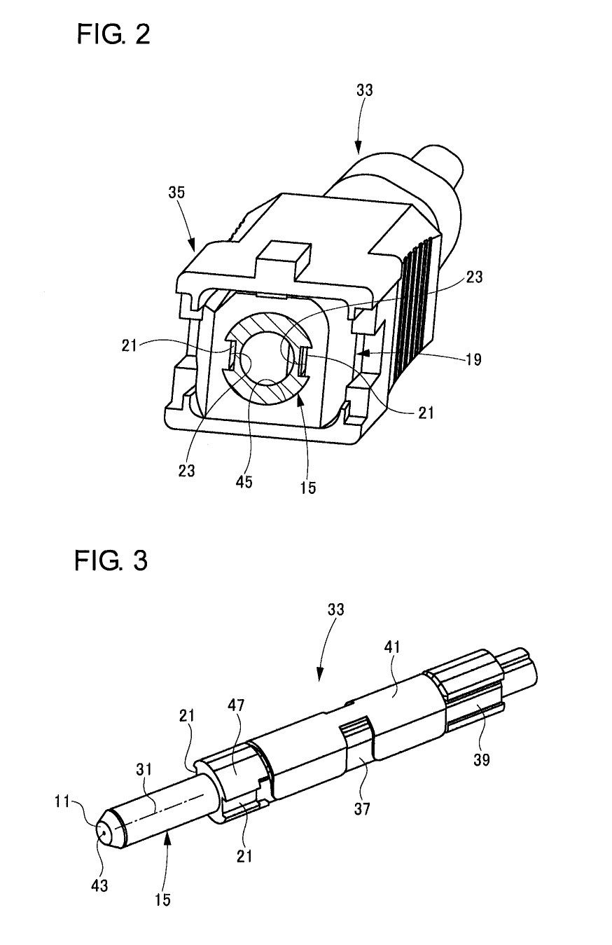

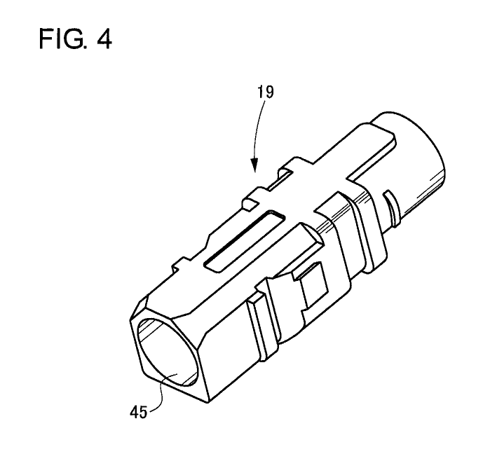

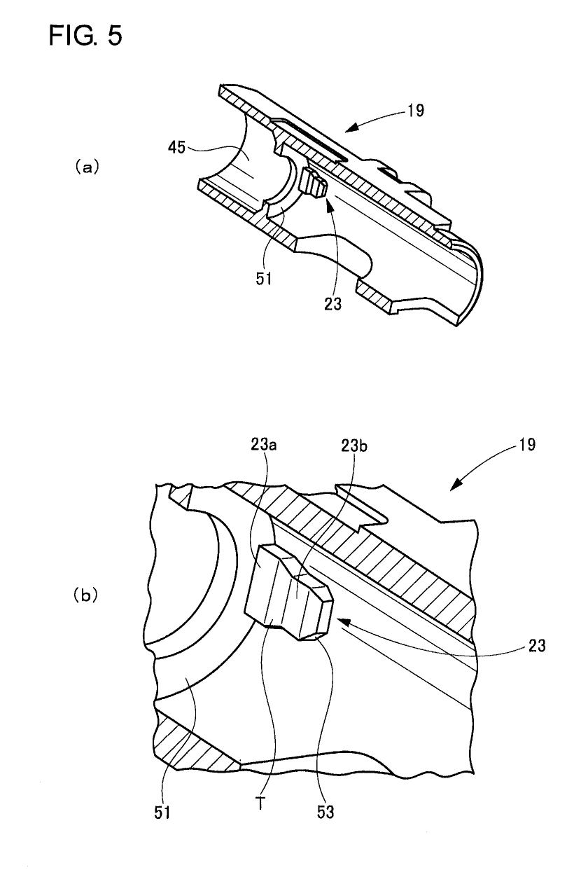

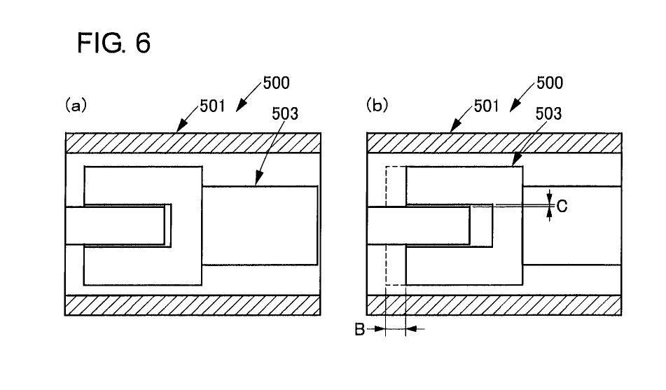

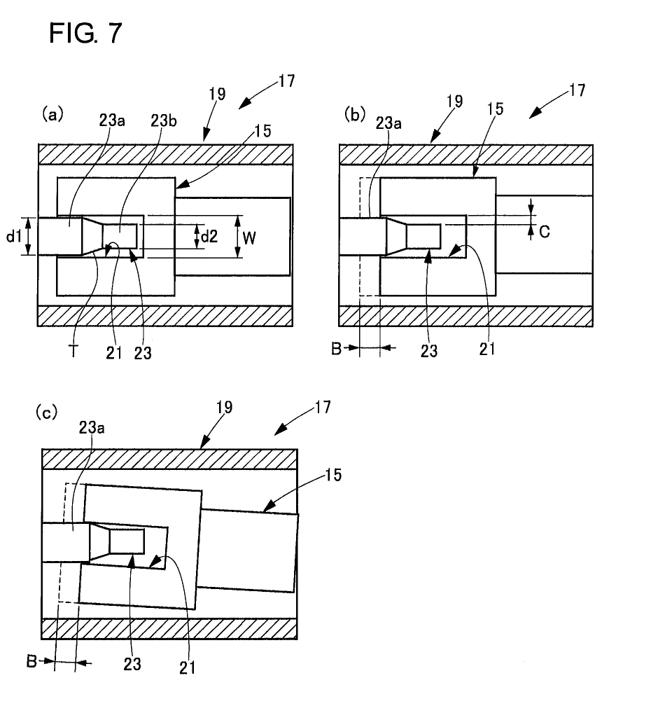

FIG. 1 is a perspective outside view of an optical connector 17 according to an embodiment of the present invention. FIG. 2 is a cross-sectional view of a main part of the optical connector 17, and FIG. 3 is a perspective view of a mechanical splice 33 contained in the optical connector 17. The optical connector 17 mainly comprises a mechanical splice 33, a housing 19 for accommodating and holding the mechanical splice 33, and a grip 35 provided on the outside of the housing 19 and used as a holding part at the time of coupling with a connector.

The mechanical splice 33 comprises a ferrule 15, a base member 37, a fixing part 39, and a damper 41 for fixing an optical fiber (not shown) by pushing a cover against the base member 37. The ferrule 15, which has a minute hole 43 for inserting an optical fiber, is put in a ferrule housing hole 45 inside the housing 19, the central axis of the ferrule 15 being substantially coincident with that of the hole 45. The ferrule 15 is made of zirconia or glass.

The front portion 11, which has an opening of the minute hole 43, of the ferrule 15 is processed by angle polish. The ferrule 15 in the housing 19 is capable of moving in a direction along an axis 31, with pressing force being afforded toward the front portion 11 by an elastic means (e.g., spring) (not shown) contained in the housing 19. A flange 47 is formed at a substantially central section in terms of the axial direction of the ferrule 15. When the flange 47 butts against the stopper wall 51 protruding in the ferrule housing hole 45 (FIG. 5), the flange 47 prevents the ferrule 15 from excessively moving further in the coupling direction.

The ferrule 15 enables an optical fiber, which is processed for termination, to be connected with an optical fiber line of a counterpart optical connector when the front portion 11 of the ferrule 15 butts against the ferrule of the counterpart optical connector. When the ferrule 15 butts against the ferrule of the counterpart optical connector, it is pushed back in the coupling direction within the deformation range of the elastic means. This enables preventing the coupling end face from being damaged by excessive stress concentration, and the pressing force of the elastic means functions as a butting force for the ferrules so that the target coupling loss can stably be obtained.

FIG. 4 is a perspective view of a housing 19 contained in the optical connector 17. In FIG. 5, area (a) is a perspective view of the housing 19 as seen by partially cutting away at a plane including the axis; area (b) is an enlarged partial view of area (a). The optical connector 17 has, between the housing 19 and the ferrule 15, a key groove 21 and a key 23 which are engaged so that their relative movement may be possible in the movement direction. The key groove 21 and the key 23 may be formed on either side of the housing 19 and the ferrule 15, and in the case of the optical connector 17, the key 23 is formed on the inner side of the housing 19 and the key groove 21 is formed on the outer side of the ferrule 15. In the optical connector 17, two pairs of the key groove 21 and the key 23 are provided at both sides in terms of diametrical direction; however, the key groove 21 and the key 23 may be provided with one pair, or more than two pairs with respect to the circumferential direction.

The optical connector 17 is an angle PC connector in which back-reflected light is extremely decreased and low coupling loss is realized. That is, in the optical connector 17, the coupling end face is angled and has a convex spherical shape so that back-reflected light may be led outside of the fiber. The back-reflected light, which is due to discontinuity of refractive index in an optical line, is caused by existence of an air layer at a coupling point or a machining-damage layer generated by processing the end face of an optical fiber, or the like. If such back-reflected light returns to a semiconductor laser which is a light source, it will cause mode interference and variation in luminescence power or oscillation frequency.

In the APC optical connector 17, in order to reduce back-reflected light, a sufficiently large tilt angle is chosen so that insertion loss will not be increased. The larger the slant angle of fiber end face, the smaller the back-reflected light will become; on the other hand, the less the connector coupling reliability will become. Therefore, the oblique angle is determined at the minimum value within the allowable limit in terms of back-reflected light. It is said that the optimal tilt angle for stably achieving return loss is about 8 degrees. (“The recent trend of ultra-low reflection angled PC connector” The Institute of Electronics, Information and Communication Engineers: IEICE technical report EMD 96-95 (1997-01))

An inherent problem of APC is a rotation about the axis 31 of the ferrule 15. If disparity in the rotation angle occurs, the center of curvature will shift. It is important to suppress the rotational angle of the ferrule 15 to 2 degrees or less in order to achieve stable PC coupling of APC faces. In order to stabilize the characteristic more, it would be sufficient if such rotation is eliminated.

In FIG. 6, areas (a) and (b) are schematic diagrams of main part of a conventional optical connector 500 as seen before and after the retreat of a ferrule in the conventional optical connector, respectively. In the conventional optical connector 500, the ferrule 503 is positioned inside the housing 501 so that the ferrule 503 may not rotate. If the clearance C of the key 509 and the key groove 507 is made smaller, control of the rotation can be made more strictly. However, when coupling of the connector 500 with another connector is done by butting, variation in the relative angle between the key 509 and the key groove 507 is also regulated according to the clearance C even if the ferrule 503 retreats by given distance B. Consequently, if external force is added to the housing 501, the force will be directly added to the PC coupling face of the connector, and accordingly the PC coupling will become unstable, which will tend to increase coupling loss.

In FIG. 7, areas (a) and (b) show schematic diagrams of main part of the optical connector 17, as seen before and after the retreat of the ferrule, respectively; area (c) is a schematic diagram of main part of the optical connector 17, as seen at a headshake of the ferrule. In the optical connector 17, the clearance C between the key 23 and the groove width W in the key groove 21 increases along the direction in which the ferrule 15 retreats. The key groove 21 is formed in parallel with the axis 31 in the flange 47 (FIG. 3) of the ferrule 15. On the other hand, the key 23 is formed on the stopper wall 51 (FIG. 5) so as to extend along the axis 31 toward the rear side of the housing 19, and the key width gradually decreases along the axis 31 toward the tip. More specifically, the key 23 is formed in a shape including base portion 23a, which has a width d1 substantially corresponding with the groove width W of the key groove 21, front portion 23b, whose width d2 is narrower than the base portion 23a and which is connected with the base portion 23a via taper portion T, and front chamfered portion 53 (FIG. 5).

In the optical connector 17, the rotation and headshake of the ferrule 15 are controlled with high precision by engagement of the key groove 21 with the base portion 23a of the key 23 until the ferrule 15 accomplish PC coupling with a counterpart connector. When the ferrule 15 retreats by a given distance B because of contraction of the elastic means upon PC coupling, the rotation of the ferrule 15 is regulated by the clearance between the base portion 23a and the key groove 21 (area (b)). As to the head-shake (variation in the relative angle between the key and the key groove), since the clearance between the groove width of the key groove 21 and the key 23 increases along the direction in which the ferrule retreats, the maximum allowance for the variation in the relative angle between the key and the key groove becomes larger; that is, the head-shake of the ferrule becomes possible (area (c)), and consequently even if an external force is added to the housing 19, it would have little effect on the PC coupling.

The key 23 and the key groove 21 are structured such that the maximum allowance for relative rotational movement about their axis 31 is equal before and after the retreat of the ferrule. That is, the engagement between the base portion 23a and the key groove 21 is maintained before and after the retreat of the ferrule (FIG. 7, area (b)). The effect of rotational control, however, decreases when the interval between the key 23 and the key groove 21 becomes larger according to the retreat of the ferrule. The structure thus obtained is such that the control of the rotation is maintained by keeping the small clearance even if the longitudinal overlapping length is short and the maximum allowance for variation in the relative angle between the key and the key groove is increased, resulting in ease of the head-shake of the ferrule 15; and an external force, even if added to the housing 19, will have less effect.

FIG. 8 is a schematic diagram of a main part of a modified example of an optical connector according to the present invention. In the optical connector 17, the key groove 21 is a parallel groove and the key 23 has a width which gradually decreases toward the front tip; conversely, in the modified example, the key 23 is modified to a parallel key 23A, while the key groove 21 is modified to a key groove 21A whose width gradually increases toward the longitudinally inner side. In the modified example also, the rotation and the head-shake are controlled with high precision until the ferrule 15 accomplish PC coupling, and when the ferrule 15 retreats by a given distance 13, the clearance between the groove width of the key groove 21A and the key 23A increases along the direction in which the ferrule retreats; thus, even if the restraint is eased (i.e., the head-shake is allowed, while the rotation is regulated), it is made possible that an external force which is added to the housing 19 can hardly have effect on PC coupling.

### INDUSTRIAL APPLICABILITY

The invention is suitable for an optical connector used in an optical fiber communications system.

### CITATION LIST

### Patent Literature

Patent document 1: Japanese Patent Application Publication No. H10-221568

Patent document 2: Japanese Patent Application Publication No. 2002-6174

1. An optical connector comprising:
a ferrule having an angle-polished end face;
a housing for accommodating and holding the ferrule, allowing the ferrule to move in the axial direction;
an elastic means for pushing the ferrule forward in the coupling direction; and further comprising
a key and a key groove provided between the housing and the ferrule, wherein
the key and the key groove are engaged with each other so as to allow their relative movement along the axial direction, and wherein
the clearance between the key and the key groove increases along the direction of the ferrule's retreat.

2. An optical connector according to claim 1, wherein
the maximum allowance for relative rotational movement as defined by the key and the key groove about their axis is equal before and after the retreat of the ferrule.
